(19) United States
(12) Patent Application Publication
(10) Pub. No.: US 2005/0180366 A1
(43) Pub. Date: Aug. 18, 2005

(54) Voice over internet communications convergence system

(76) Inventor: Matthew W. Excell, Hurricane, UT (US)

Correspondence Address: M. REID RUSSELL, 854 WEST 3390 SOUTH, HURRICANE, UT, 84737, US

(21) Appl. No.: 10/777,853

(22) Filed: Feb. 13, 2004

(51) Int. Cl. H04Q 7/24

(52) U.S. Cl. 370/338

(57) ABSTRACT

The invention is in a system for providing telephone service between points that does not rely on conventional or legacy local loop technologies and includes a demarc consisting of components that replace equipment as is currently utilized by such conventional or legacy telephone carriers. The components that make up the demarc of the invention convert an analog audio signal to digital form that is encoded, compressed, and possibly encrypted for transmission, as by way of the internet, to a subscriber who can even be a conventional or legacy telephone subscriber, providing telephone communications between parties.

### BACKGROUND OF THE INVENTION

1. Field of the Invention

This invention pertains to a system for providing residential/commercial telephone services over a data network such as the internet.

2. Prior Art

The present invention is in a system for providing standard residential/commercial telephone services that is independent of existing or legacy telephone systems. While, heretofore, written communications such as E-mail and even video and audio communications have been available over the internet, such communications have been separate from connection through existing telephone lines. The invention recognizes the existence of a demarc system at the residence or business where the wire end of the telephone line owned by the legacy telephone system connects to the residence or business phone lines and, at this demarc, connects the residence or business phone lines to a computer that provides for connection over a broad band to an internet server, or to a like wireless device or service. So arranged, the internet server is in constant communication with the residence or business phone wiring to carry calls over the internet and into the telephone system without a need for a connection to a legacy telephone system. Further, the server can connect cell phone signals over the same broad band to the subscribers computer and telephone system and can also provide video signals accompanying the audio, within the scope of the invention. Heretofore, and prior to the invention, the existing residential and business telephone systems have been separate from and generally non-accessible over the internet or like wireless services.

### SUMMARY OF THE INVENTION

It is a principal object of the present invention to provide residential/commercial telephone type services that do not rely on conventional or legacy telephone technology.

Another object of the present invention is to provide a demarc system apparatus for the conversion of analog audio to digital data that can be encoded, compressed, and, as required, encrypted for transmission from the demarc system and sent to another subscriber or to an existing conventional or legacy telephone system located at a residence or commercial establishment.

Another object of the present invention is to provide, with the encryption of the analog signal, a data packet that can be transmitted via a data network to a data processing point that is the equivalent of a central office as is used by a conventional or legacy telephone carrier.

Another object of the present invention is to provide for a transmission of digital data by wireless transmission to connect to, for example, a cable modem, an IP by transmission over a power line, or via any other internet type system.

Still another object of the present invention is to provide a communications system that enables a by-passing of conventional telephone land line services and provides for instant messaging to and from anywhere in the world over an internet type system or wireless service.

Still another object of the present invention is to provide a capability for either direct point-to-point communications between a source to a target or, where direct the source and target are not both subscribers, for connection through a conventional or legacy service by use of a call processor as a router that is operated for the duration of the call.

Still another object of the present invention is to provide a system for communication over an internet type service or wireless service where both a source and target are each connected to conventional or legacy services.

Still another object of the present invention is in a communications system that provides routing capabilities for end to end transmissions that include voice-mail, fax, email, voice menu and other voice and telephone driven functions, that is expandable and extensible through software upgrades, and is independent from a requirement for connections through conventional or legacy telephone systems.

The present invention is in a system that provides standard residential/commercial telephone services with no reliance on existing or legacy local cable and wire loop technologies. With the invention, analog audio data is converted to digital date, encoded, compressed, and, optionally, encrypted at a demarc system for transmission via a data network, such as a broad band internet type service to a processing point. From which processing point, that is functionally like a central office as is used by a conventional or legacy telephone carrier, the digital data package can be transmitted over a broad band internet type carrier; can be sent via cable modem; as a data transmission over power lines; or by other internet type medium; or can be sent by wireless transmission, such as over a cell phone.

In practice, the demarc system includes a group of components that include a junction or interface between conventional or legacy telephone lines and residence or business wiring at the customers residence or business location. This junction is generally a box mounted to provide ready access to the residence or business owner and allows for installing the components of the invention across the house or residence wiring, severing the connection with the conventional or legacy telephone lines. With the demarc further including a switch for linking the housing wiring to the junction and other system components.

### DESCRIPTION OF THE DRAWINGS

The invention may take physical form in certain parts and arrangements of parts, and a preferred embodiment of which will be described in detail in this specification and illustrated in the accompanying drawings, which form a part hereof:

FIG. 1 is a flow schematic showing the components of the invention in a communications convergence system of the invention that includes a demarc and its components and shows the component interaction and operation to provide a communications system for residential and business use that is independent from a conventional or legacy local loop telephone technologies;

FIG. 2 is a block flow schematic showing a conversion of an analog signal into digital packet date at a demarc of the invention;

FIG. 3 is a block flow schematic showing the handling by the invention of an analog signal at the demarc with a resulting digital packet of data transmitted via a data network to a call processing point;

FIG. 4A is a block flow schematic showing an extension routing capability to the demarc for connection to networked phones, mobile phones, and voice of internet protocol (VoIP) software, and showing handling of calls originating from and/or going to conventional or legacy telephone circuits;

FIG. 4B is a block flow schematic showing an example of a network transmission from the demarc to a conventional or legacy telephone circuit;

FIG. 4C is a block flow schematic showing an example of a connection of a conventional or legacy telephone circuit to a demarc; and

FIG. 5 is a block flow schematic showing an encryption of the digital packet data passed from a digital end-point to any other digital end-point for providing secure, private communications between points.

### DETAILED DESCRIPTION

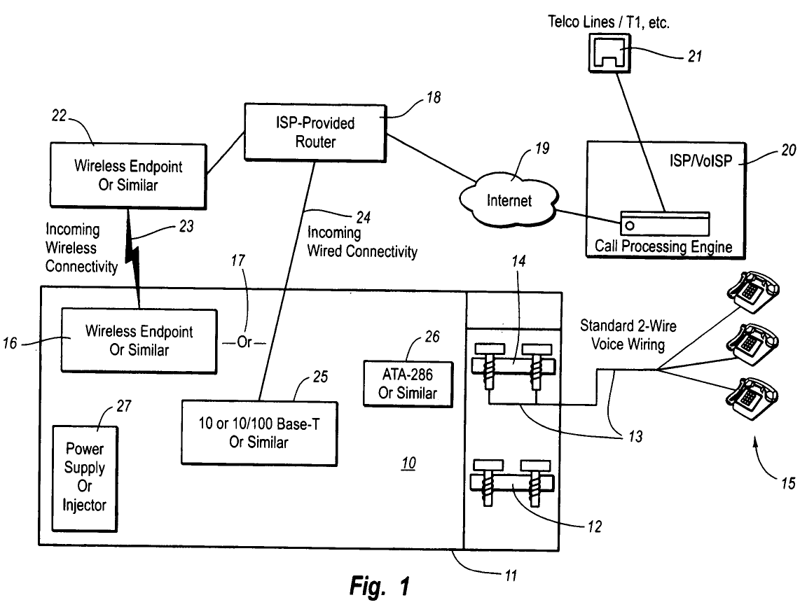

The invention is in a communications convergence system that includes a combination of apparatus for providing standard residential/commercial telephone and related communications services that is independent from conventional or legacy local loop technologies. Conventional or legacy local loop technologies wiring connects to a residential or commercial telephone system at a junction box 11 that, as shown in FIG. 1, is also a component of a demarc 10 of the communications convergence system, which junction box 11 is located at the residence or commercial facility. At the junction box 11, the house or business side of the box that connects to the internal wiring, shown as a bar 12, is owned by and the responsibility of the owner, with the other side of the box connected to the conventional or local legacy loop of a telephone system 15, that is shown as a plurality of telephones, and is the responsibility of the communications company. Prior to an installation of the system of the invention, the bars 12 and 14 are electrically connected and provide a residence/business service connection into the conventional or legacy system. In an installation of the invention the connection to the local legacy loop is bypassed at the junction box 11, with the residence or commercial facility phone wiring connected through an internal wireless receiver access point that is within the demarc 19 and is shown at block 16 that, in practice, is preferably a D-Link DWL-2000AP/DWL-900+, or similar unit, that is commonly known as an access point, and provides a first access point within the demarc to the system. This unit can be hard wired, as shown, to connect through wires 17 identified as “Or” to a provider ISP router 18 that is an internet router, providing for connection to the internet, shown as a cloud 19, that is linked to a call processing engine 20, preferably an ISP/VoISP, known as a service provider, that receives data through Telco lines, shown at block 21, as has been encrypted in digital form and is routed to the ISP router, shown as block 18. The internal wireless receiver 16 can be wirelessly connected to a source of bandwidth within the structure, or to a wireless ISP. Additionally, an external wireless receiver access point 22 that is also preferably a D-Link DWL-2000AP, DWL-900AP+, or equivalent unit, identified as block 22, is used to supply connectivity from the ISP router, block 18, modem and/or to supply connectivity from the demarc to other wireless clients, with the signal as it passes shown as a lightening bolt 23, illustrating a radio signal. Further, the system can be upgraded with new technology for providing wireless connectivity to other wireless accessories in the home or office environment as, for example, computers, networked phones, appliances, game consoles, and others, within the scope of this disclosure.

The ISP provided router 18 connects to a switch 25 through wire 24 that the wireless endpoint 16 is also connected to through line “Or” 17. The switch 25 is located within the demarc 10 and is preferably a Netgear EN 1108TP, or an equivalent switch, and is used to route packets of digital data within the demarc. In practice, a category 3 cable or above is used to connect the switch 25 to other components within the demarc, which switch, shown as block 25, provides for a 10 or 10/100 base-T, capability, to effect network access. The category 3 cable ends are joined by connector, such as RJ45 connectors, but another connector can be so used within the scope of this disclosure.

Also within the demarc 10 is fitted an analog telephone adapter, or adapters, illustrated at block 26, as an ATA-286 or similar unit, that is for converting an analog voice stream, as generated by each phone line in the residence/business location, into binary packet data for transmission from the demarc 10 to a receiving end-point. A power supply or injection is shown at block 27 to supply power to the other components of the demarc 10 or, alternatively, an internal power supply, not shown, may be connected into the unit linking it to the region's standard power.

As set out above, the demarc 10 is preferably located in a box, cabinet, or the like, at the residence or business and, in practice, a weatherproof enclosure that includes terminals for connecting it to premises wiring, and a preferred demarc terminator case 11 is one manufactured by Corning, identified as a CAC7600, though a like enclosure can be so used within the scope of this disclosure.

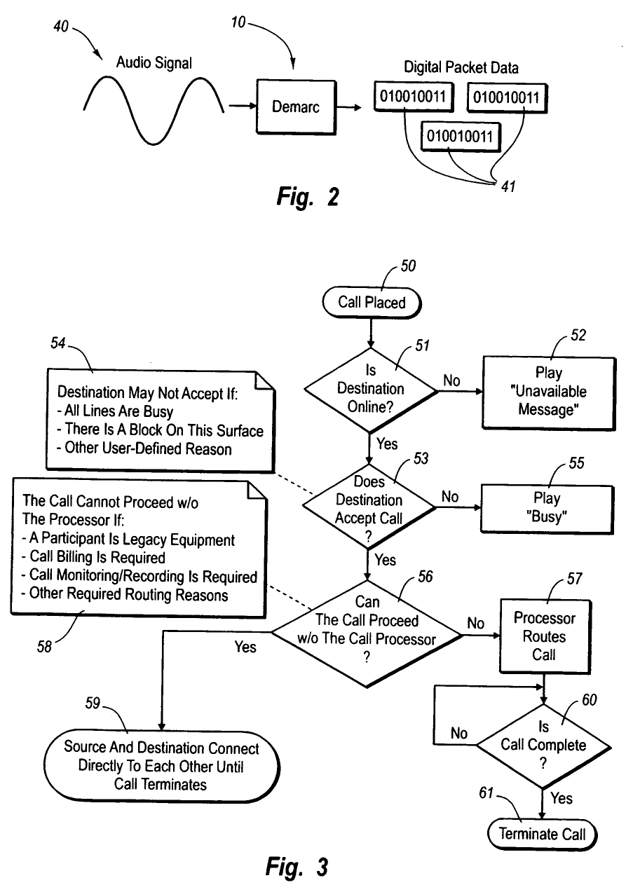

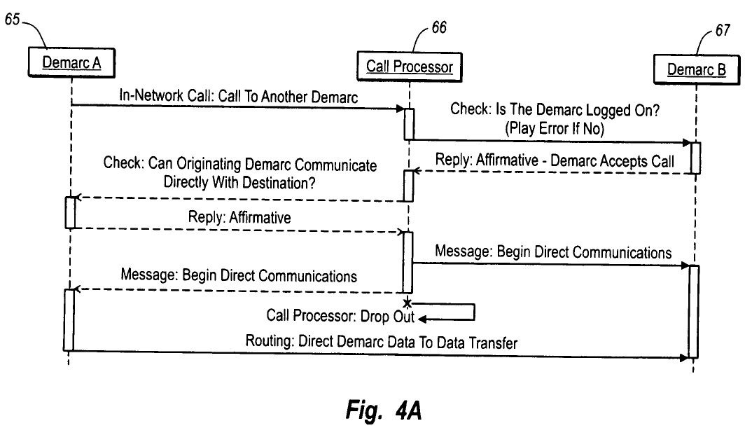

FIG. 2 shows the demarc 10 as receiving an audio analog signal 40 and converting that analog data into digital packets 41. The digital signal is then transmitted via a data network to a data processing point that is essentially the equivalent of a central office as is used by a conventional or legacy telephone carrier. This can also be done without wires with the demarc, for such wireless transmission, to provide wireless connectivity to an additional wireless device or devices and appliances, as, for example, via cable modem, IP over power lines, or via any other internet connection. At the data processing point, the call is routed, again over the Internet or other available network, to the destination point. FIG. 3 shows a block flow of the call handling.

FIG. 3 illustrates that, in a practice of the invention, point-to-point routing is possible between a source and target destination, with the call processor dropping out of the connection, and the demarcs systems at the connected points initiating data transfer directly between one another. Whereas, if direct connection is normally not possible, as when one end of the connection is a conventional or legacy telephone circuit, the call processor will then act as a router for the duration of the call. In the block flow of FIG. 3, the call is placed at block 50 and, if a destination is on line, shown at block 51, either an unavailable message, block 52, is received, or the destination accepts the call, block 53. Alternatively, shown at a bloc 54 that is connected by a broken line to block 53, the destination may not accept the call if: all lines are busy; there is a block on the line; or other user-defined reason. Additionally, if the destination point is busy, shown at block 55, the caller receives a busy signal. The call, from block 53, passes to a call proceed block 56, where, if the system includes a call processor, the call is passed to block 57 that indicates the processor routing the call. Whereas, if there is not a call processor, as indicated by the line identified as “No”, the call, as indicated by a broken line connection to block 58, can proceed without the processor if: a participant is a linked to conventional or legacy equipment; if call billing is required, if call monitoring/recording is required; or for other routing reasons. If such criterion is present, the call proceeds, as indicated by a line identified as “Yes”, to the destination, block 59, and is maintained until the call is terminated. With, if the processor routes the call, the call proceeds with the called party answering and talking, block 60, until terminated, block 61.

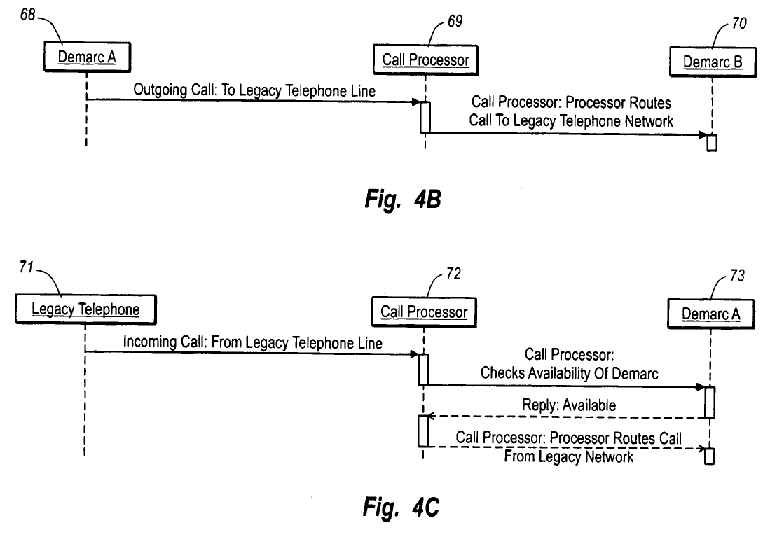

In addition, the system can provide call and extension capabilities to other demarc phone systems, to networked phones, mobile phones and VoIP software, and can handle calls that originate or terminate with conventional or legacy telephone circuits, as necessary. The call processor of the system can provide voice mail, fax, email, voice menu, and other IVR functions and is expandable and extensible through software upgrade to any and all of these types of end point stations. FIG. 4A shows an example of network transmission where the sender and receiver stations each have the system of the invention installed. In such system, a demarc A, block 65, initiates the call that passes through a call processor, block 66, to demarc B, block 67. As shown, a call is originated at demarc A, block 65, and passes through the call processor 66 directly to the demarc B, block 67, that accepts the call and replies to demarc A acknowledging the connection and the message or messages are then exchanged, with the call processor dropping out. This constitutes a direct demarc data to data transfer.

FIG. 4B illustrates a network to conventional or legacy system transfer, showing a demarc A, block 68, initiating an outgoing call through a call processor, block 69, to demarc B, block 70. Similarly, as shown in FIG. 4C, a conventional or legacy system, block 71, initiates a call through a call processor, block 72, to a network demarc A, block 73. To make a call from the conventional or legacy network, after passage through the call processor that is located with the demarc A, block 73, first checks availability of the demarc A to the incoming call. If the demarc A is open to receive the call, the call processor then routes that call from the legacy network.

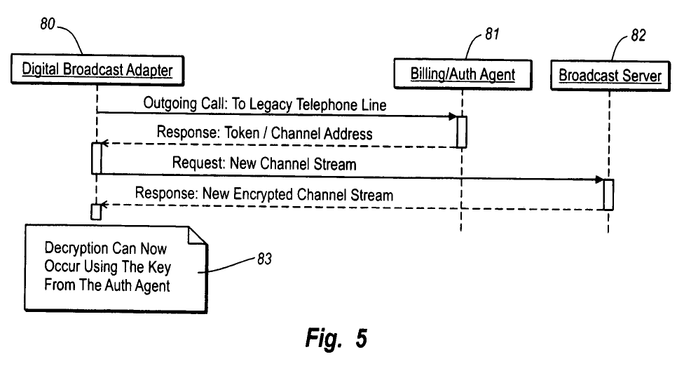

The system of the invention has further capabilities to receive from and/or transmit to other present and future communication systems. For example, FIG. 5 shows an illustration of a channel-based analog transmission that is received at a digital broadcast adapter 80. Such transmission, shown as a broken line, connects to a legacy telephone line, shown as a solid line arrow, to obtain authority for the transmission from a billing/authorization agent, block 81. With the billing/authorization agent, block 81, responding by assigning a channel address, shown as a broken line, with the transmission proceeding as a request for a new channel stream, solid line, passed to a broadcast server, block 82. The broadcast server, in turn, provides for an encryption of the transmission that passes, as a new channel stream, shown as broken lines, to the call destination, shown as a point of decryption, block 83, where the authorized decryption can take place for the receipt of the transmission.

The above is an example of a handling of a cell phone type transmission where legacy type mobile phones (2G and 3G for example), without VoIP or 802.11 wireless capabilities, are accessed via an existing mobile telephone network. Such phones can be accessed through legacy telephone circuits, or a call processor can be connected into the mobile telephone network, thereby allowing mobile calls to be handled without the calls crossing legacy telephone circuits. In the future, phones like those presently identified as 4G phones, will roam on existing mobile networks and can be accessed like a present conventional or legacy mobile phones, as illustrated in FIG. 5. When so arranged, such future phone can act as an extension, like the demarc of the invention, or other networked phone, that do not require a use of a conventional or legacy telephone circuit. Additionally, as other technologies for mobile phones are created, call processors and demarcs like those of the invention, will allow calls to be transferred into and out of such mobile phone network. Further, for present and future systems, the call processors and demarc of the invention can provide encryption from an digital end-point to any other digital end-point to provide for secure, private communications between points. Finally, it should be understood, the invention is sufficiently flexible to allow for additions that will allow for connection to other analog media, such as television, routed into the system via the processors and demarc of the invention.

Herein is shown embodiments of my invention in a voice over internet communications convergence system. It will, however, be apparent to one knowledgeable or skilled in the art that the above described embodiments may incorporate changes and modifications without departing from the general scope and subject matter of the invention. Which invention. it should be understood, is intended to include all such modifications and alterations in so far as they come within the scope of the appended claims and/or a reasonable equivalence thereof.

1. A communications convergency system comprising, a demarc system for location in a structure that is a residence or commercial establishment; a housing arranged for mounting to said structure and wherein said demarc system components are maintain; and said demarc system includes: an internal wireless receiver access point that acts as an access point to the system and is for connection to a source of bandwidth; an external wireless receiver that is external to said structure and acts as an access point that receives conductivity from an ISP modem within the structure and supplies connectivity from the demarc system of other clients within said structure; a switch that is used to route data packets within the demarc system and is connected to the demarc system components within the housing; an analog telephone adapter for converting an analog voice stream into binary packet data for each phone line within said structure; and a source of power connected to supply power to said demarc system components.

2. The communications convergence system as recited in claim 1, further including an ISP router that is external to the structure containing the demarc system and connects the demarc system to a processing engine for connection into the internet.

3. The communications convergence system as recited in claim 2, wherein the ISP router provides a connection in an internet network.

4. The communications convergence system as recited in claim 1, further including a wireless end point for receiving radio transmissions as from a cell phone or wireless access point that is for connection into the demarc system switch, with that radio transmission passed for processing into binary packet data and transmitted to a phone line.

5. The communications convergence system as recited in claim 1, wherein the demarc can be located within or outside of the structure and individual components thereof can be fitted into multiple enclosures to simplify installation.
